(19) United States
(12) Patent Application Publication
(10) Pub. No.: US 2018/0213959 A1
(43) Pub. Date: Aug. 2, 2018

(54) MATS FOR ADJUSTABLE DESKS

(71) Applicant: Deflecto, LLC, Indianapolis, IN (US)

(72) Inventors: Patrick Foley, Indianapolis, IN (US); Jack Hamman, Indianapolis, IN (US); Gretchen Russell, Indianapolis, IN (US); Robert Rafter, Dover, OH (US); Matt Hamm, Dover, OH (US); Tia Thruman, Dover (US); Joseph Regula, Dover, OH (US)

(21) Appl. No.: 15/884,794

(22) Filed: Jan. 31, 2018

Related U.S. Application Data
(60) Provisional application No. 62/452,508, filed on Jan. 31, 2017.

(51) Int. Cl. A47G 27/02; B32B 7/12; B32B 5/18; B32B 3/30; B32B 3/26; B32B 27/08; B32B 27/06; B32B 27/30

(52) U.S. Cl. CPC A47G 27/0231; A47G 27/0206; A47G 27/0281; B32B 7/12; B32B 5/18; B32B 3/30; B32B 2471/04; B32B 27/08; B32B 27/065; B32B 27/304; B32B 2250/04; B32B 2307/744; B32B 2307/41; B32B 3/263

(57) ABSTRACT

A chair mat including a first layer, a second layer, and a third layer, wherein the first layer includes a plastic, wherein the second layer includes an adhesive, wherein the third layer includes a cushioning foam, wherein the second layer is interposed between the first layer and the third layer, wherein the first layer is more rigid than the third layer.

### CROSS-REFERENCE TO RELATED APPLICATIONS

This application claims a benefit of priority to U.S. Provisional Patent Application 62/452,508 filed 31 Jan. 2017, which is herein incorporated by reference for all purposes.

### TECHNICAL FIELD

This disclosure relates to mats.

### BACKGROUND

Some studies suggest that long periods of sitting are detrimental to human health. As such, various adjustable-height desks have become popular. Since those desks are often used with wheeled chairs in carpeted environments, different types of chair mats are often used for carpet protection and convenient chair use. However, since a typical chair mat is neither designed for, nor conducive to, long periods of standing, this situation leads to user discomfort, which reduces some beneficial impact of the adjustable-height desks. Therefore, the typical chair mat is not suitable for use with the adjustable-height desks. Likewise, a typical standing mat may be cushioned for standing user comfort, but unable to effectively withstand weight and impact of a wheeled chair, while enabling convenient chair use. Therefore, the typical standing mat is also not suitable for use with the adjustable-height desks.

### SUMMARY

In an embodiment, a device comprises: a chair mat including a first layer, a second layer, and a third layer, wherein the first layer includes a plastic, wherein the second layer includes an adhesive, wherein the third layer includes a cushioning foam, wherein the second layer is interposed between the first layer and the third layer, wherein the first layer is more rigid than the third layer.

In an embodiment, a method comprises: accessing a first layer and a second layer, wherein the first layer includes a plastic, wherein the second layer includes a cushioning foam, wherein the first layer is more rigid than the second layer; and securing the first layer to the second layer chemically such that a chair mat is formed.

In an embodiment, a method comprises: positioning a chair mat on a surface in proximity of a desk that is adjustable between a first height from the surface and a second height from the surface, wherein the chair mat includes a first layer, a second layer, and a third layer, wherein the first layer includes a plastic, wherein the second layer includes an adhesive, wherein the third layer includes a cushioning foam, wherein the second layer is interposed between the first layer and the third layer, wherein the first layer is more rigid than the third layer; sitting on a chair including a caster wheel such that the caster wheel rolls on the first layer as the desk is at the first height and the chair is in proximity of the desk; and standing on the first layer in proximity of the desk as the desk is at the second height.

Note that this disclosure may be embodied in various forms illustrated in a set of accompanying illustrative drawings and variations are contemplated as being a part of this disclosure, limited only by a scope of various claims recited below.

### DESCRIPTION OF DRAWINGS

The set of accompanying illustrative drawings shows various example embodiments of this disclosure. Such drawings are not to be construed as necessarily limiting this disclosure. Like numbers or similar numbering scheme can refer to like or similar elements throughout.

FIG. 1 shows a perspective top view of an embodiment of a chair mat according to this disclosure.

FIG. 2 shows a perspective bottom view of an embodiment of a chair mat according to this disclosure.

FIG. 3 shows a top view of an embodiment of a chair mat according to this disclosure.

FIG. 4 shows a bottom view of an embodiment of a chair mat according to this disclosure.

FIG. 5 shows a longitudinal side view of an embodiment of a chair mat according to this disclosure.

FIG. 6 shows a lateral side view of an embodiment of a chair mat according to this disclosure.

FIG. 7 shows a partial cross-sectional view of an embodiment of a chair mat according to this disclosure.

FIG. 8 shows a perspective bottom view of an embodiment of a corner portion of a chair mat according to this disclosure.

FIG. 9A shows a side view of an embodiment of a chair mat in use with an adjustable-height desk when the adjustable-height desk is in a sitting mode according to this disclosure.

FIG. 9B shows a side view of an embodiment of a chair mat in use with an adjustable-height desk when the adjustable-height desk is in a standing mode according to this disclosure.

FIG. 10 shows a perspective top view of an embodiment of a chair mat according to this disclosure.

FIG. 11 shows a perspective bottom view of an embodiment of a chair mat according to this disclosure.

FIG. 12A shows a side view of an embodiment of a chair mat in use with an adjustable-height desk when the adjustable-height desk is in a sitting mode according to this disclosure.

FIG. 12B shows a side view of an embodiment of a chair mat in use with an adjustable-height desk when the adjustable-height desk is in a standing mode according to this disclosure.

### DETAILED DESCRIPTION OF PREFERRED EMBODIMENTS

This disclosure is now described more fully with reference to the set of accompanying illustrative drawings, in which example embodiments of this disclosure are shown. This disclosure may, however, be embodied in many different forms and should not be construed as necessarily being limited to the example embodiments disclosed herein. Rather, the example embodiments are provided so that this disclosure is thorough and complete, and fully conveys various concepts of this disclosure to those skilled in a relevant art.

Features described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity in any manner.

Various terminology used herein can imply direct or indirect, full or partial, temporary or permanent, action or inaction. For example, when an element is referred to as being “on,” “connected” or “coupled” to another element, then the element can be directly on, connected or coupled to the other element and/or intervening elements can be present, including indirect and/or direct variants. In contrast, when an element is referred to as being “directly connected” or “directly coupled” to another element, there are no intervening elements present.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from various teachings of this disclosure.

Various terminology used herein is for describing particular example embodiments and is not intended to be necessarily limiting of this disclosure. As used herein, various singular forms “a,” “an” and “the” are intended to include various plural forms as well, unless a context clearly indicates otherwise. Various terms “comprises,” “includes” and/or “comprising,” “including” when used in this specification, specify a presence of stated features, integers, steps, operations, elements, and/or components, but do not preclude the presence and/or addition of one or more other features, integers, steps, operations, elements, components, and/or groups thereof.

As used herein, a term “or” is intended to mean an inclusive “or” rather than an exclusive “or.” That is, unless specified otherwise, or clear from context, “X employs A or B” is intended to mean any of a set of natural inclusive permutations. That is, if X employs A; X employs B; or X employs both A and B, then “X employs A or B” is satisfied under any of the foregoing instances.

Example embodiments of this disclosure are described herein with reference to illustrations of idealized embodiments (and intermediate structures) of this disclosure. As such, variations from various illustrated shapes as a result, for example, of manufacturing techniques and/or tolerances, are to be expected. Thus, various example embodiments of this disclosure should not be construed as necessarily limited to various particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing, and/or other any other types of manufacturing. For example, some manufacturing processes include three dimensional (3D) printing, laser cutting, computer numerical control routing, milling, pressing, stamping, vacuum forming, hydroforming, injection molding, lithography, and so forth.

Any and/or all elements, as disclosed herein, can be and/or include, whether partially and/or fully, a solid, including a metal, a mineral, an amorphous material, a ceramic, a glass ceramic, an organic solid, such as wood and/or a polymer, such as rubber, a composite material, a semiconductor, a nanomaterial, a biomaterial and/or any combinations thereof. Any and/or all elements, as disclosed herein, can be and/or include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, opaqueness, luminescence, reflection, phosphorescence, anti-reflection and/or holography, a photo-sensitive coating, an electronic and/or thermal property coating, such as for passivity, insulation, resistance or conduction, a magnetic coating, a water-resistant and/or waterproof coating, a scent coating and/or any combinations thereof. Any and/or all elements, as disclosed herein, can be rigid, flexible, and/or any other combinations thereof. Any and/or all elements, as disclosed herein, can be identical and/or different from each other in material, shape, size, color and/or any measurable dimension, such as length, width, height, depth, area, orientation, perimeter, volume, breadth, density, temperature, resistance, and so forth.

Unless otherwise defined, all terms (including technical and scientific terms) used herein have the same meaning as commonly understood by one of ordinary skill in an art to which this disclosure belongs. Various terms, such as those defined in commonly used dictionaries, should be interpreted as having a meaning that is consistent with a meaning in a context of a relevant art and should not be interpreted in an idealized and/or overly formal sense unless expressly so defined herein.

Furthermore, relative terms such as “below,” “lower,” “above,” and “upper” can be used herein to describe one element's relationship to another element as illustrated in the set of accompanying illustrative drawings. Such relative terms are intended to encompass different orientations of illustrated technologies in addition to an orientation depicted in the set of accompanying illustrative drawings. For example, if a device in the set of accompanying illustrative drawings were turned over, then various elements described as being on a “lower” side of other elements would then be oriented on “upper” sides of other elements. Similarly, if a device in one of illustrative figures were turned over, then various elements described as “below” or “beneath” other elements would then be oriented “above” other elements. Therefore, various example terms “below” and “lower” can encompass both an orientation of above and below.

As used herein, a term “about” and/or “substantially” refers to a +/−10% variation from a nominal value/term. Such variation is always included in any given value/term provided herein, whether or not such variation is specifically referred thereto.

If any disclosures are incorporated herein by reference and such disclosures conflict in part and/or in whole with this disclosure, then to an extent of a conflict, if any, and/or a broader disclosure, and/or broader definition of terms, this disclosure controls. If such disclosures conflict in part and/or in whole with one another, then to an extent of a conflict, if any, a later-dated disclosure controls.

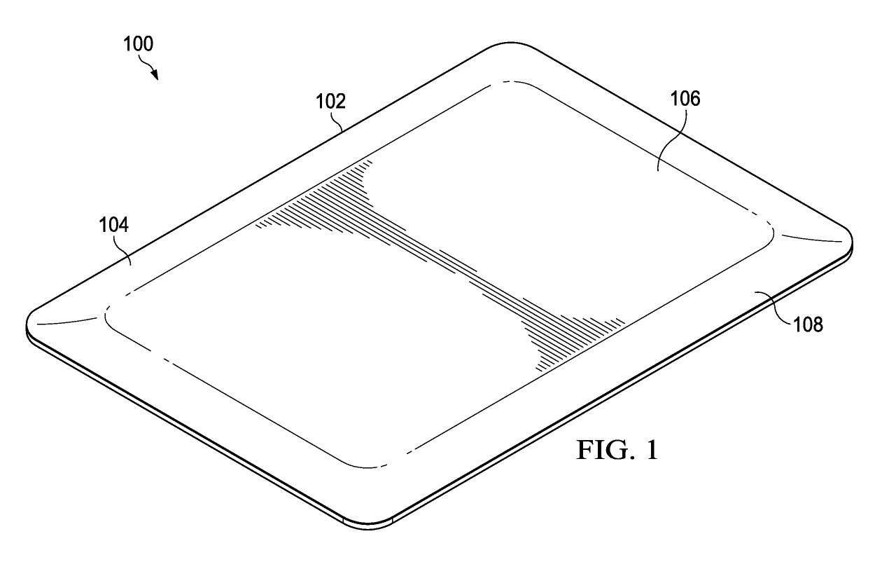

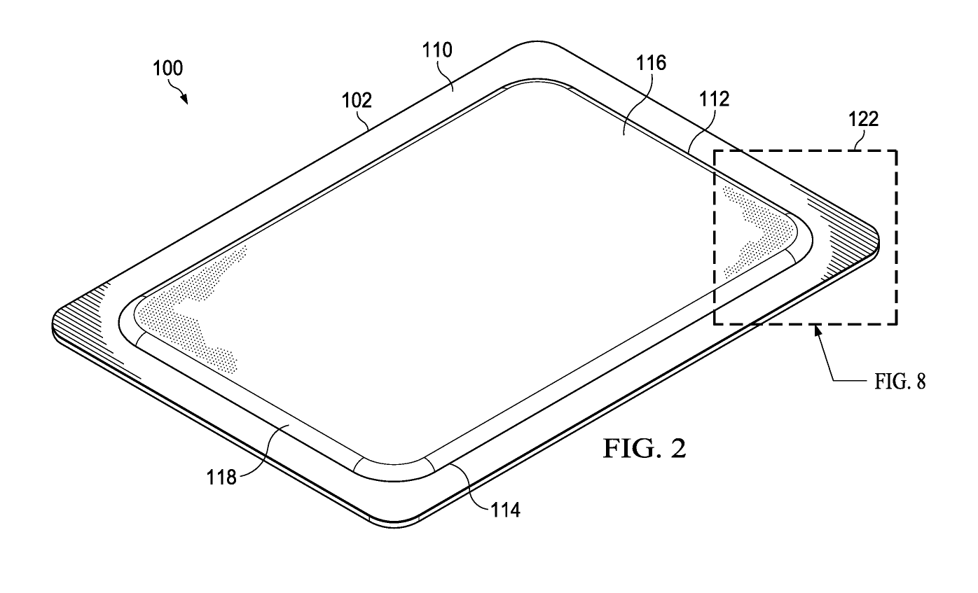

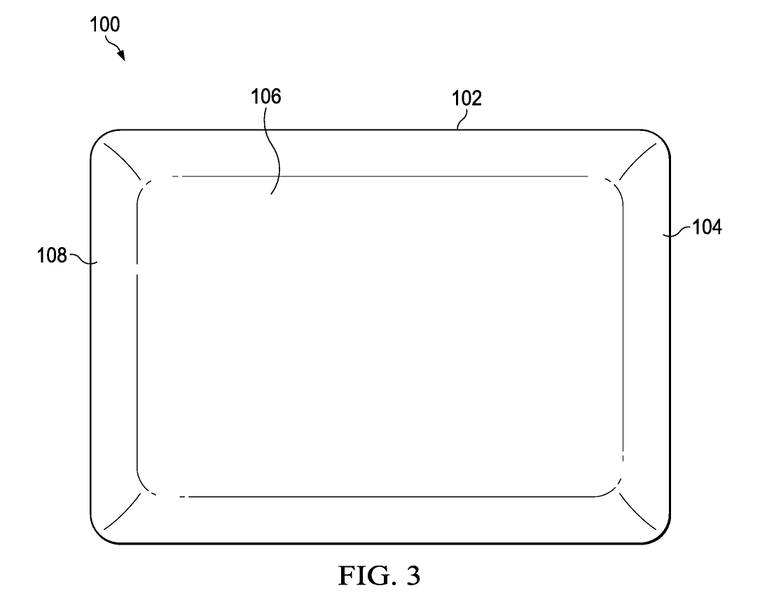

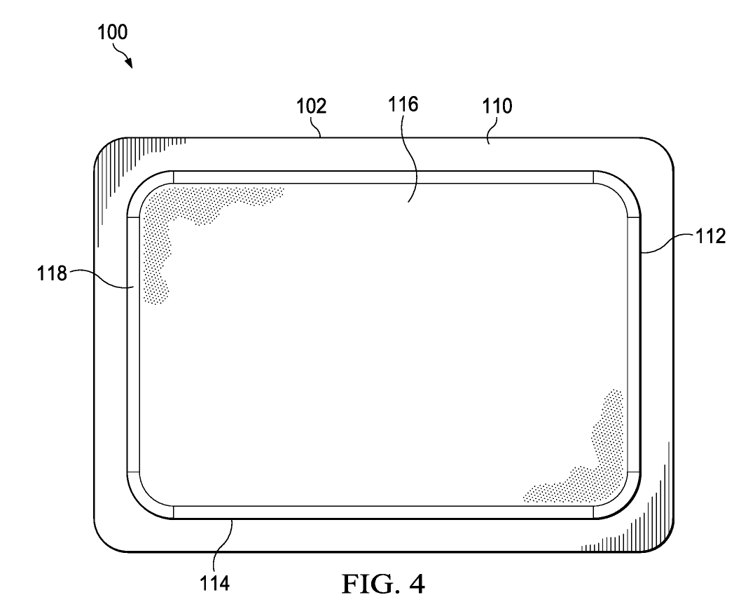

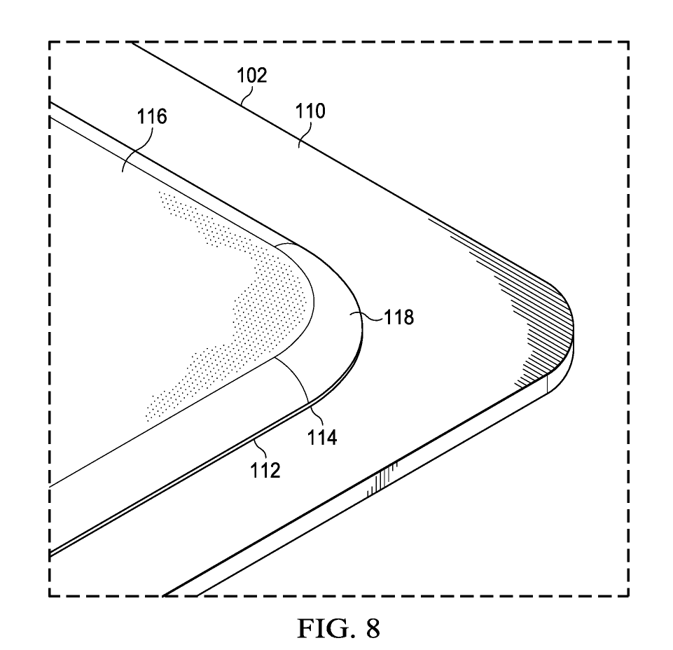

FIG. 1 shows a perspective top view of an embodiment of a chair mat according to this disclosure. FIG. 2 shows a perspective bottom view of an embodiment of a chair mat according to this disclosure. FIG. 3 shows a top view of an embodiment of a chair mat according to this disclosure. FIG. 4 shows a bottom view of an embodiment of a chair mat according to this disclosure. FIG. 7 shows a partial cross-sectional view of an embodiment of a chair mat according to this disclosure. FIG. 8 shows a perspective bottom view of an embodiment of a corner portion of a chair mat according to this disclosure. In particular, a chair mat 100 includes an upper layer 102 and a lower layer 112, which can be identical to or different from each other in structure, material, dimension, function, property, use, or other characteristics. The chair mat 100 further includes an adhesive layer 120 interposed between the upper layer 102 and the lower layer 112 such that the adhesive layer 120 adheres to the upper layer 102 and the lower layer 112, thereby securing the upper layer 102 and the lower layer 112 to each other.

The upper layer 102 is rectangular in shape, but can be shaped differently, such as a circle, an oval, a square, a triangle, a pentagon, a hexagon, D-shape, a trapezoid, a tapered shape, or any other shape, whether symmetric or asymmetrical, whether open shaped or closed shaped. The upper layer 102 is uniform in thickness, but can vary in thickness. The upper layer 102 is opaque, but can be transparent or translucent. The upper layer 102 includes a plastic, such as a polyvinyl chloride (PVC) or others. However, note that other materials can be used, whether additionally or alternatively, such as a rubber, a wood, a metal, a vinyl, a polypropylene, a foam, or others. The upper layer 102 can be solid or perforated. The upper layer 102 can include a living hinge such that the upper layer 102 is segmented into a pair of portions, whether equal or unequal, whether symmetrical or asymmetrical, and is able to fold thereabout, whether enclosing the lower layer 112 or being enclosed via the lower layer 112.

The upper layer 102 includes a main portion 106 and a peripheral portion 108. The peripheral portion 108 extends along or about the main portion 106 in a beveled, chamfered, or another inclined or ramped manner, although straight edge form of extension is possible. The upper layer 102 includes a top surface 104 and a bottom surface 110. The top surface 104 is sufficiently planar and smooth to enable a caster wheel of a chair to smoothly roll thereon, such as on the main portion 106 or the peripheral portion 108, while also being configured to be non-slip. The top surface 104 is irregular in texture, but can be regular in texture. The top surface 104 can be textured to prevent slippage, while being resistant to wear and tear of footwear and chairs. For example, the upper layer 102, including the top surface 104, may be constructed using a variety of materials for increased durability and damage-resistance or in order to resist wear and tear of dress shoes, high heels, office chairs, or other footwear, rollers, or objects.

The lower layer 112 is rectangular in shape, but can be shaped differently, such as a circle, an oval, a square, a triangle, a pentagon, a hexagon, D-shape, a trapezoid, a tapered shape, or any other shape, whether symmetric or asymmetrical, whether open shaped or closed shaped. The lower layer 112 is uniform in thickness, but can vary in thickness. For example, the lower layer 112 can be 0.5 inches thick or less. The lower layer 112 is opaque, but can be transparent or translucent.

The lower layer 112 can include a living hinge such that the lower layer 112 is segmented into a pair of portions, whether equal or unequal, whether symmetrical or asymmetrical, and is able to fold thereabout, whether enclosing the upper layer 102 or being enclosed via the upper layer 102. The lower layer 112 can be solid or perforated. The lower layer 112 includes a cushioning material, such as a foam, whether open or closed cell, a neoprene, a soft rubber, an elastic material, a viscoelastic material, or others. For example, the lower layer 112 can include a memory foam or others. For example, the lower layer 112 can include a polyurethane, such as a low-resilience polyurethane or others. For example, the lower layer 112 can be configured such that the lower layer 112 can be compressed from its original configuration and then return to its original configuration, such as in 30 minutes or less. As such, the upper layer 102 is more rigid than the lower layer 112.

The lower layer 112 includes a top surface 114, a bottom surface 116, and a wall 118. The wall 118 spans between the top surface 114 and the bottom surface 116 in a beveled or chamfered manner, although straight edge extension is possible, such as perpendicular. The upper layer 102 is greater in area or perimeter than the lower layer 112 such that the main portion 106 extends over the lower layer 112 and the peripheral portion 108 extends past the lower layer 112. Resultantly, the peripheral portion 108 is beveled or chamfered away from the main portion 106 such that the lower layer 112 is covered by the peripheral portion 108 when the lower layer 112 rests on a flat surface, such as a floor, whether a hard floor surface or a carpeted surface. For example, the floor surface can include a concrete, a cement, a plastic, a wood, a carpet, a metal, a rubber, a linoleum, or others. Likewise, the wall 118 is beveled or chamfered towards the upper layer 102, such as towards the bottom surface 110.

In some embodiments, the bottom surface 116 is non-skid or can host a projection, a depression, a groove, a spike, a stud, or other structural form that engages with a floor surface, whether a hard floor surface or a carpeted surface, in order to increase friction and thereby reduce skidding or sliding of the bottom surface 116 on the floor surface. For example, the floor surface can include a concrete, a cement, a plastic, a wood, a carpet, a metal, a rubber, a linoleum, or others. For example, the bottom surface 116 designed for use on a hardwood surface or a vinyl surface may include a non-skid coating or texture in order to prevent slippage across the hardwood surface or the vinyl surface.

In some embodiments, the bottom surface 110 of the peripheral portion 108, which extends past the lower layer 112, can host a projection, a depression, a groove, a spike, a stud, or other structural form that engages with a floor surface, whether a hard floor surface or a carpeted surface, in order to increase friction and thereby reduce skidding or sliding of the bottom surface 110 on the floor surface. For example, the floor surface can include a concrete, a cement, a plastic, a wood, a carpet, a metal, a rubber, a linoleum, or others.

In some embodiments, the upper layer 102 can include a lip, such as via the main portion 106 or the peripheral portion 108. Note that the lip can avoid including or include the lower layer 112. The lip can host a projection, a depression, a groove, a spike, a stud, or other structural form that engages with a floor surface, whether a hard floor surface or a carpeted surface, in order to increase friction and thereby reduce skidding or sliding of the lip on the floor surface. For example, the floor surface can include a concrete, a cement, a plastic, a wood, a carpet, a metal, a rubber, a linoleum, or others.

In some embodiments, the lower layer 112 can be covered, encased, or enveloped by a protective layer that is secured to the upper layer 102, such as via the bottom surface 110. As such, the lower layer 112 is interposed between the adhesive layer 120 and the protective layer. The protective layer can be secured via adhering, stitching, mating, interlocking, fastening, hook-and-looping, bonding, or others. The protective layer can be dome-shaped when covering, encasing, or enveloping the lower layer 112. The protective layer can include a fabric, a rubber, a plastic, a wood, a metal, a leather, or other materials. The protective layer can be transparent, translucent, or opaque. The protective layer can be solid or perforated, whether rigid or flexible. The protective layer can include an outermost surface that avoids facing the inner layer 112, where the outermost surface is non-skid or can host a projection, a depression, a groove, a spike, a stud, or other structural form that engages with a floor surface, whether a hard floor surface or a carpeted surface, in order to increase friction and thereby reduce skidding or sliding of the protective layer on the floor surface. For example, the floor surface can include a concrete, a cement, a plastic, a wood, a carpet, a metal, a rubber, a linoleum, or others. For example, the outermost surface of the protective layer designed for use on a hardwood surface or a vinyl surface may include a non-skid coating or texture in order to prevent slippage across the hardwood surface or the vinyl surface.

The adhesive layer 120 is interposed between the upper layer 102 and the lower layer 112 such that the adhesive layer 120 binds the upper layer 102 and the lower layer 112 to each other and resists separation thereof. For example, the adhesive layer 120 can include a synthetic adhesive, such as a spray adhesive or a liquid adhesive. The adhesive layer 120 can extend in any way between the upper layer 102 and the lower layer 112. For example, the adhesive layer 120 can have any patterns or shape of deposition or extension, whether closed or open shape, whether symmetrical or asymmetrical, such as an O-shape, a D-shape, an N-shape, an M-shape, a W-shape, a T-shape, an L-shape, a J-shape, an I-shape, an S-shape, an H-shape, a Z-shape, an X-shape, a C-shape, a U-shape, a V-shape, a polygonal shape, a circle, an oval, a polka dot pattern, a zigzag pattern, a sinusoidal pattern, an arcuate pattern, a pulse pattern, or any others. In some embodiments, the upper layer 102 and the lower layer 112 are secured to each other in other ways, such as sewing, mechanical fastening, thermal bonding, or others. For example, the mechanical fastening can include a hook-and-loop fastener or others.

The chair mat 100 may be embodied in various dimensions and can be manufactured in various ways. For example, the chair mat 100 can include 0.133 inch gauge (for the upper layer 102) in sizes of about 45 inches by about 53 inches or about 46 inches by about 60 inches with an about ⅜ inch thick no-slip PVC sponge (for the lower layer 112) cut to about 43 inch by about 51 inch or about 44 inch by about 58 inch, angled bevel, and applied via adhesion with a spray gun to the bottom surface 110. For example, the lower layer 112 can include a PVC closed cell polymeric ⅜ inch thick foam. This foam is bevel cut such that the foam will lay down flat in use. Then, an adhesive (the adhesive layer 120) is applied with a spray guy across the top surface 114 of the foam. The foam can be laid on the bottom surface 110, such as via following an outline or pattern. For example, the bottom surface 110 can be laid flat for at least 48 hours prior to assembly with the foam (the lower layer 112) such that the bottom surface 110 is flat or relatively flat (as opposed to curved). For example, the upper layer 102 and the lower layer 112 can be secured to each other chemically, mechanically, or other ways. For example, the upper layer 102 and the lower layer 112 can be secured to each other chemically via interposing an adhesive between the upper layer 102 and the lower layer 112.

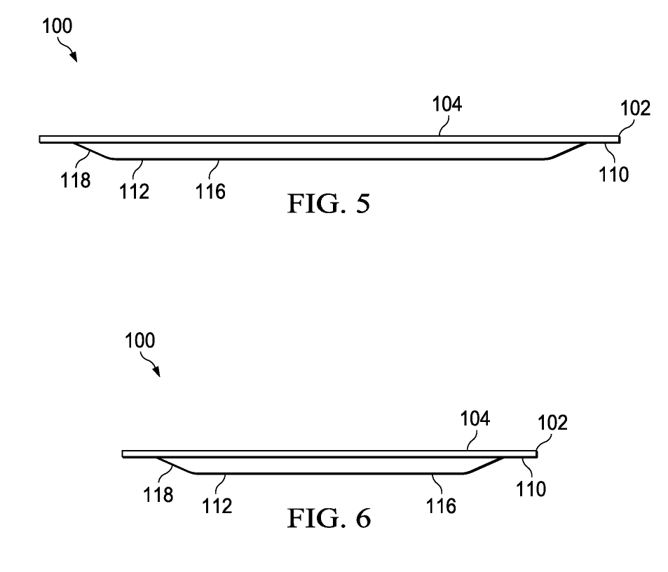

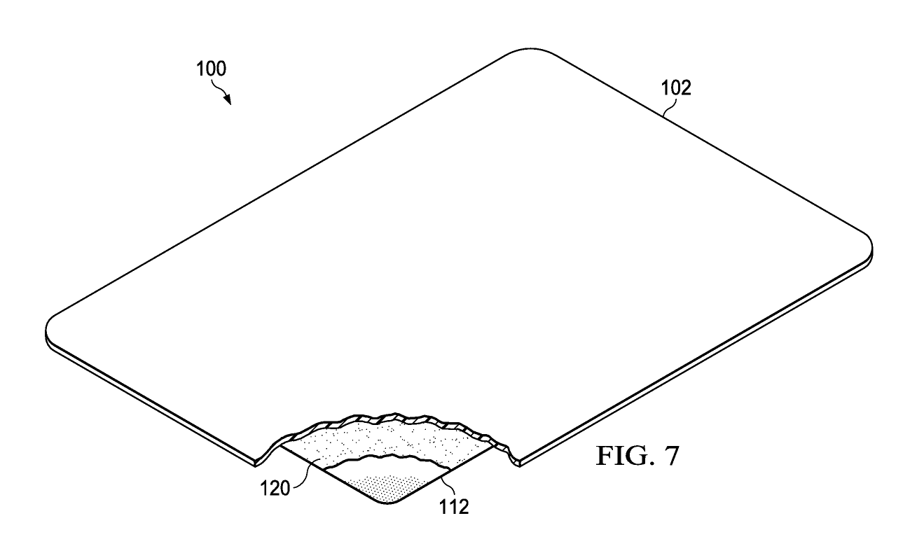

FIG. 5 shows a longitudinal side view of an embodiment of a chair mat according to this disclosure. FIG. 6 shows a lateral side view of an embodiment of a chair mat according to this disclosure. In particular, the peripheral portion 108 is extending rectilinearly, such as when the peripheral portion 108 is not beveled or chamfered away from the main portion 106, such as when the peripheral portion 108 is sufficiently rigid to remain in that configuration or sufficiently elastic to return to that configuration.

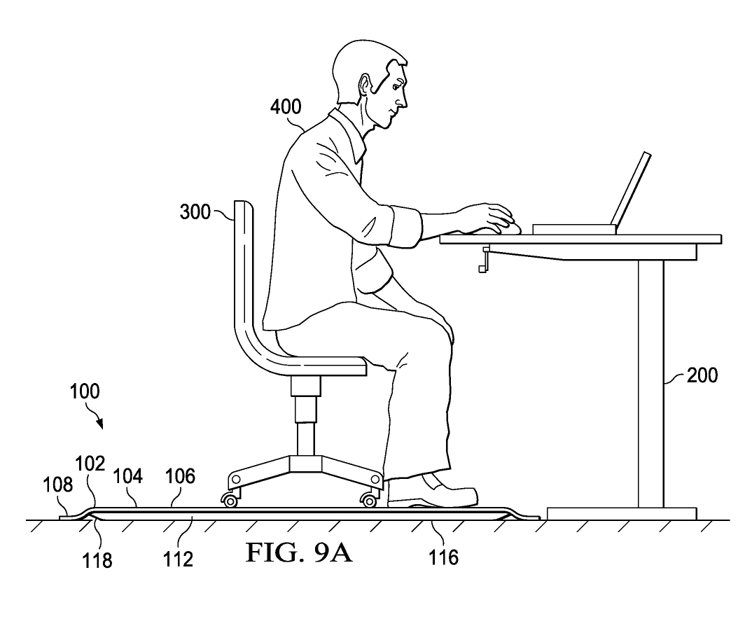

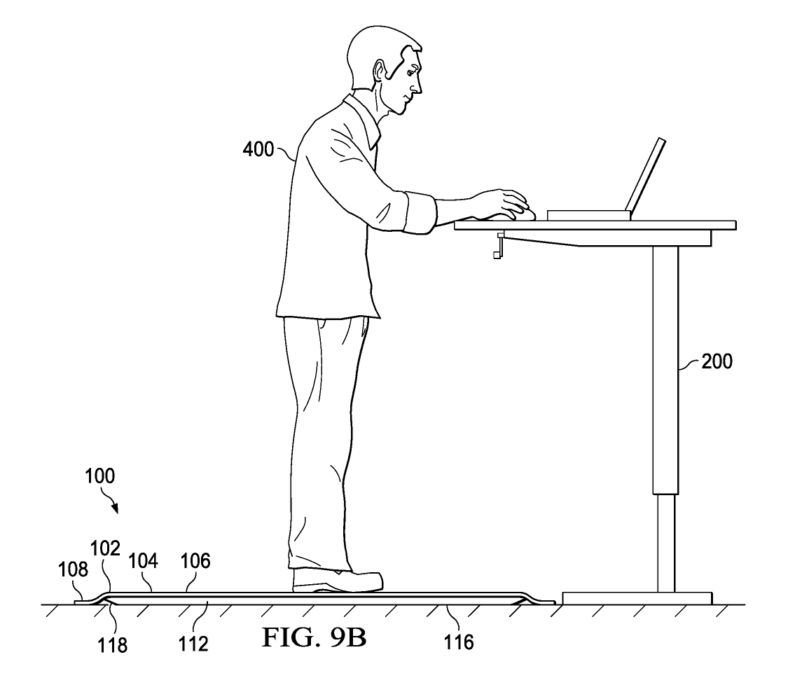

FIG. 9A shows a side view of an embodiment of a chair mat in use with an adjustable-height desk when the adjustable-height desk is in a sitting mode according to this disclosure. In particular, the chair mat 100 is resting on a ground surface, whether a hard floor surface or a carpeted surface, in proximity of an adjustable-height desk 200, which is also resting on the ground surface, such as within about 5 feet of the chair mat 100 or less. Likewise, the main portion 106 supports a wheeled chair 300 thereon via the top surface 104 such that the wheeled chair 300 is positioned over the lower layer 112 as a user 400 is sitting on the wheeled chair 300. Resultantly, the chair mat 100 provides the wheeled chair 300 with a suitable surface to roll on.

FIG. 9B shows a side view of an embodiment of a chair mat in use with an adjustable-height desk when the adjustable-height desk is in a standing mode according to this disclosure. In particular, when the user 400 desires to work standing, without the wheeled chair 300, the user 400 stands on the main portion 106 via the top surface 104 such that the user 400 is positioned over the lower layer 112. Resultantly, the lower layer 112 provides a cushioned support to the user 400. Accordingly, as shown in FIGS. 9A and 9B, the chair mat 100 is capable of supporting a load distributed in different ways depending how adjusted the adjustable-height desk 200 is and an orientation of the user 400. For example, a method of using the chair mat 100 can include positioning the chair mat 100 on the ground surface in proximity of the adjustable-height desk 200 that is adjustable between a first height from the surface and a second height from the ground surface, where the chair mat 100 includes the upper layer 102, the adhesive layer 120, and the lower layer 112, and where the upper layer 102 includes a plastic, and where the adhesive layer 120 includes an adhesive, and where the lower layer 112 includes a foam, with the adhesive layer 120 being interposed between the upper layer 102 and the lower layer 112. The method further includes having the user 400 sit on the wheeled chair 300 such that the wheeled chair 300 rolls on the upper layer 102 as the adjustable-height desk 200 is at the first height and the wheeled chair 200 is in proximity of the adjustable-height desk 200. The method additionally includes having the user 400 stand on the upper layer 102 in proximity of the adjustable-height desk 200, such as within about 5 feet or less, as the adjustable-height desk 200 is at the second height. When the upper layer 102 includes the peripheral portion 108, the user 300 can direct the wheeled chair 300 such that the wheeled chair 300 rolls on the peripheral portion 108, where the standing includes stepping onto the peripheral portion 108.

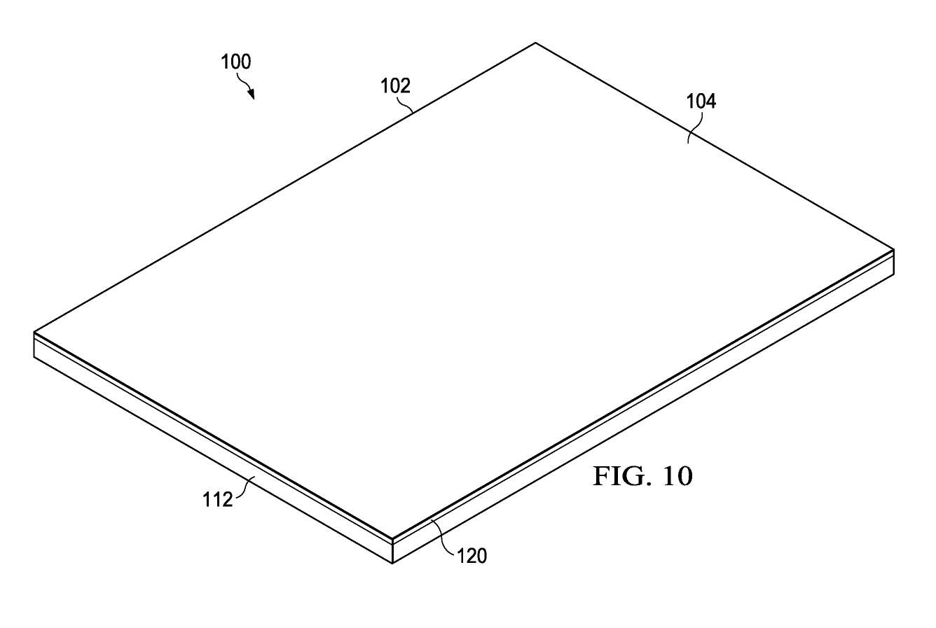

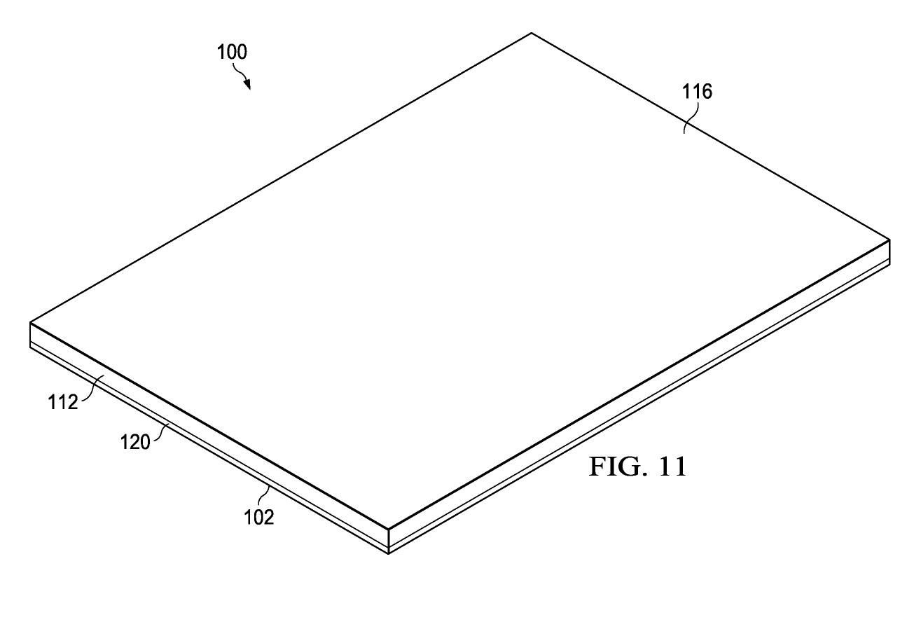

FIG. 10 shows a perspective top view of an embodiment of a chair mat according to this disclosure. FIG. 11 shows a perspective bottom view of an embodiment of a chair mat according to this disclosure. In particular, the chair mat 100 includes the main portion 106 and lacks the peripheral portion 108, where the upper layer 102 and the lower layer 112 are co-aligned along at least one side of the chair mat 100, with the adhesive layer 120 being interposed between the upper layer 102 and the lower layer 112.

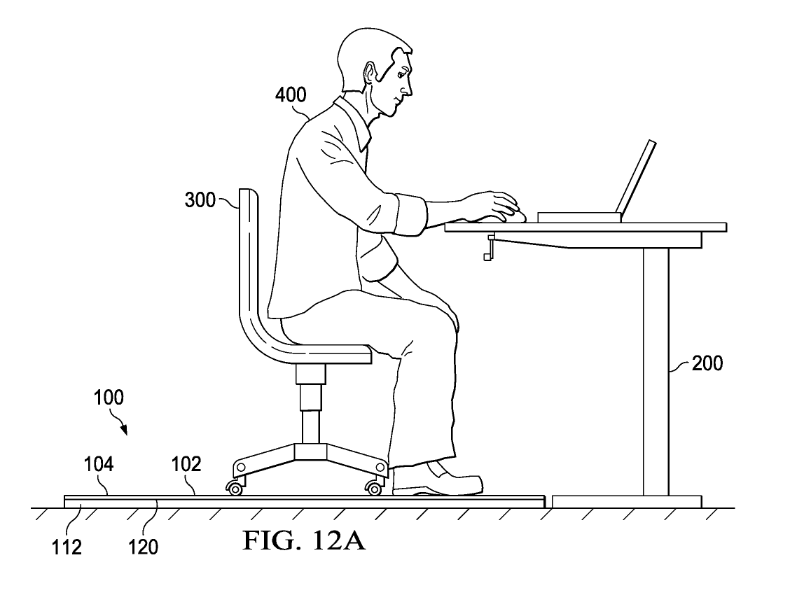

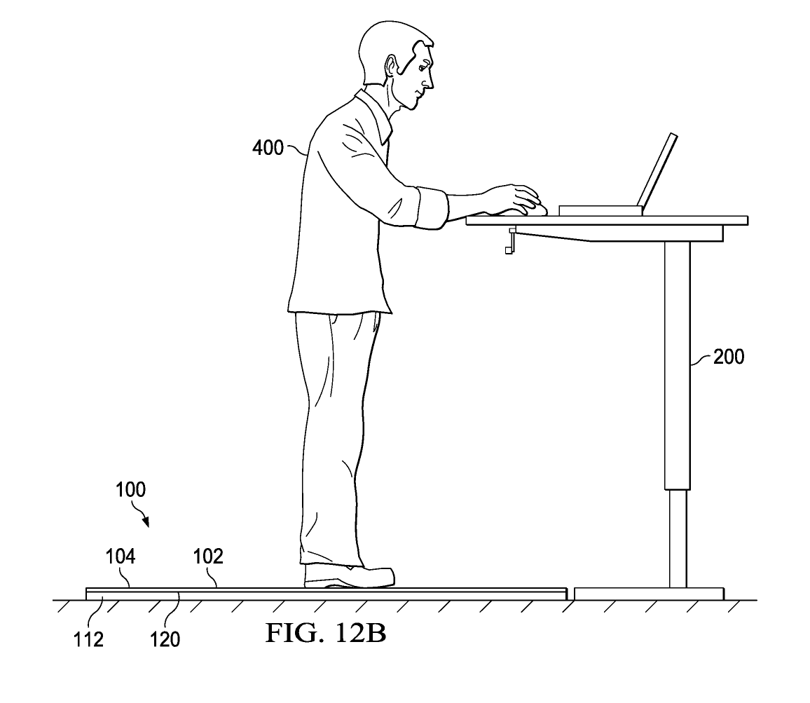

FIG. 12A shows a side view of an embodiment of a chair mat in use with an adjustable-height desk when the adjustable-height desk is in a sitting mode according to this disclosure. In particular, the chair mat 100 is resting on a ground surface, whether a hard floor surface or a carpeted surface, in proximity of the adjustable-height desk 200, which is also resting on the ground surface, such as within about 5 feet of the chair mat 100 or less. Likewise, the main portion 106 supports the wheeled chair 300 thereon via the top surface 104 such that the wheeled chair 300 is positioned over the lower layer 112 as the user 400 is sitting on the wheeled chair 300. Resultantly, the chair mat 100 provides the wheeled chair 300 with a suitable surface to roll on.

FIG. 12B shows a side view of an embodiment of a chair mat in use with an adjustable-height desk when the adjustable-height desk is in a standing mode according to this disclosure. In particular, when the user 400 desires to work standing, without the wheeled chair 300, the user 400 stands on the main portion 106 via the top surface 104 such that the user 400 is positioned over the lower layer 112. Resultantly, the lower layer 112 provides a cushioned support to the user 400. Accordingly, as shown in FIGS. 12A and 12B, the chair mat 100 is capable of supporting a load distributed in different ways depending how adjusted the adjustable-height desk 200 is and an orientation of the user 400. For example, a method of using the chair mat 100 can include positioning the chair mat 100 on the ground surface in proximity of the adjustable-height desk 200 that is adjustable between a first height from the surface and a second height from the ground surface, where the chair mat 100 includes the upper layer 102, the adhesive layer 120, and the lower layer 112, and where the upper layer 102 includes a plastic, and where the adhesive layer 120 includes an adhesive, and where the lower layer 112 includes a foam, with the adhesive layer 120 being interposed between the upper layer 102 and the lower layer 112. The method further includes having the user 400 sit on the wheeled chair 300 such that the wheeled chair 300 rolls on the upper layer 102 as the adjustable-height desk 200 is at the first height and the wheeled chair 200 is in proximity of the adjustable-height desk 200. The method additionally includes having the user 400 stand on the upper layer 102 in proximity of the adjustable-height desk 200, such as within about 5 feet or less, as the adjustable-height desk 200 is at the second height.

In some embodiments, the chair mat 100 can be packaged, whether folded, rolled, or flat, into a kit or a package with a set of instructions for a use of the chair mat 100, as disclosed herein. The set of instructions can be embodied on a storage medium included in the kit. For example, the storage medium can include a sheet of paper, a memory device, or others.

In some embodiments, various functions or acts can take place at a given location and/or in connection with an operation of one or more apparatuses or systems. In some embodiments, a portion of a given function or act can be performed at a first device or location, and a remainder of the function or act can be performed at one or more additional devices or locations.

Various corresponding structures, materials, acts, and equivalents of all means or step plus function elements in various claims below are intended to include any structure, material, or act for performing the function in combination with other claimed elements as specifically claimed. Various embodiments were chosen and described in order to best explain various principles of this disclosure and various practical applications thereof, and to enable others of ordinary skill in a pertinent art to understand this disclosure for various embodiments with various modifications as are suited to a particular use contemplated.

Various diagrams depicted herein are illustrative. There can be many variations to such diagrams or steps (or operations) described therein without departing from various spirits of this disclosure. For instance, various steps can be performed in a differing order or steps can be added, deleted or modified. All of these variations are considered a part of this disclosure. People skilled in an art to which this disclosure relates, both now and in future, can make various improvements and enhancements which fall within various scopes of various claims which follow.

This detailed description has been presented for various purposes of illustration and description, but is not intended to be fully exhaustive and/or limited to this disclosure in various forms disclosed. Many modifications and variations in techniques and structures will be apparent to those of ordinary skill in an art without departing from a scope and spirit of this disclosure as set forth in various claims that follow. Accordingly, such modifications and variations are contemplated as being a part of this disclosure. A scope of this disclosure is defined by various claims, which include known equivalents and unforeseeable equivalents at a time of filing of this disclosure.

What is claimed is:

1. A device comprising:
a chair mat including a first layer, a second layer, and a third layer, wherein the first layer includes a plastic, wherein the second layer includes an adhesive, wherein the third layer includes a cushioning foam, wherein the second layer is interposed between the first layer and the third layer, wherein the first layer is more rigid than the third layer.

2. The device of claim 1, wherein the first layer is larger in area than the third layer.

3. The device of claim 2, wherein the first layer is beveled away from the third layer.

4. The device of claim 2, wherein the first layer is chamfered away from the third layer.

5. The device of claim 2, wherein the third layer is beveled towards the first layer.

6. The device of claim 2, wherein the third layer is chamfered towards the first layer.

7. The device of claim 2, wherein the first layer is studded past the third layer.

8. The device of claim 2, wherein the first layer includes a lip past the third layer.

9. The device of claim 2, wherein the first layer includes a projection past the third layer.

10. The device of claim 1, wherein the chair mat includes a fourth layer, wherein the third layer is interposed between the second layer and the fourth layer, wherein the fourth layer is configured to increase friction and thereby avoid skidding on at least one of a carpeted surface or a hard-floor surface.

11. The device of claim 1, wherein the first layer includes a living hinge.

12. The device of claim 1, wherein the third layer includes a living hinge.

13. The device of claim 1, wherein the first layer includes a non-slip surface.

14. The device of claim 1, wherein the first layer includes a polyvinyl chloride.

15. The device of claim 1, wherein the first layer is irregular in texture.

16. The device of claim 1, wherein the first layer is opaque.

17. A method comprising:
accessing a first layer and a second layer, wherein the first layer includes a plastic, wherein the second layer includes a cushioning foam, wherein the first layer is more rigid than the second layer; and
securing the first layer to the second layer chemically such that a chair mat is formed.

18. The method of claim 17, wherein the securing includes interposing an adhesive between the first layer to the second layer.

19. A method comprising:
positioning a chair mat on a surface in proximity of a desk that is adjustable between a first height from the surface and a second height from the surface, wherein the chair mat includes a first layer, a second layer, and a third layer, wherein the first layer includes a plastic, wherein the second layer includes an adhesive, wherein the third layer includes a cushioning foam, wherein the second layer is interposed between the first layer and the third layer, wherein the first layer is more rigid than the third layer;
sitting on a chair including a caster wheel such that the caster wheel rolls on the first layer as the desk is at the first height and the chair is in proximity of the desk; and
standing on the first layer in proximity of the desk as the desk is at the second height.

20. The method of claim 19, wherein the first layer includes a portion that extends past the third layer, wherein the sitting includes directing the chair such that the caster wheel rolls on the portion, wherein the standing includes stepping onto the portion.
